(19) United States
(12) Patent Application Publication
(10) Pub. No.: US 2026/0284582 A1
(43) Pub. Date: Sep. 24, 2026

(54) CONDITIONING WET SOUR GAS VIA INTEGRATED DESULFURIZATION AND DEHYDRATION

(71) Applicant: Merichem Technologies LLC, Houston, TX (US)

(72) Inventors: Hector Rodriguez, Katy, TX (US); Edward W. Fell, Chicago, IL (US); Jeff Gomach, League City, TX (US)

(73) Assignee: Merichem Technologies LLC, Houston, TX (US)

(21) Appl. No.: 19/087,085

(22) Filed: Mar. 21, 2025

(51) Int. Cl. B01D 53/14; B01D 47/00; B01D 53/00; B01D 53/18; B01D 53/26; B01D 53/52; B01D 53/78; B01D 53/96

(52) U.S. Cl. CPC B01D 53/1468; B01D 47/00; B01D 53/002; B01D 53/1425; B01D 53/145; B01D 53/18; B01D 53/265; B01D 53/52; B01D 53/78; B01D 53/96; B01D 2251/90; B01D 2257/304; B01D 2257/702; B01D 2257/80

(57) ABSTRACT

Disclosed herein are gas conditioning systems and methods for treating hydrogen sulfide containing gas streams and, more particularly, disclosed are gas conditioning systems and methods with integrated flash gas recovery for reduced atmospheric emissions, including in one embodiment, conveying flash gases comprising flashed hydrocarbon gases and residual hydrogen sulfide from a flash drum to a suction drum.

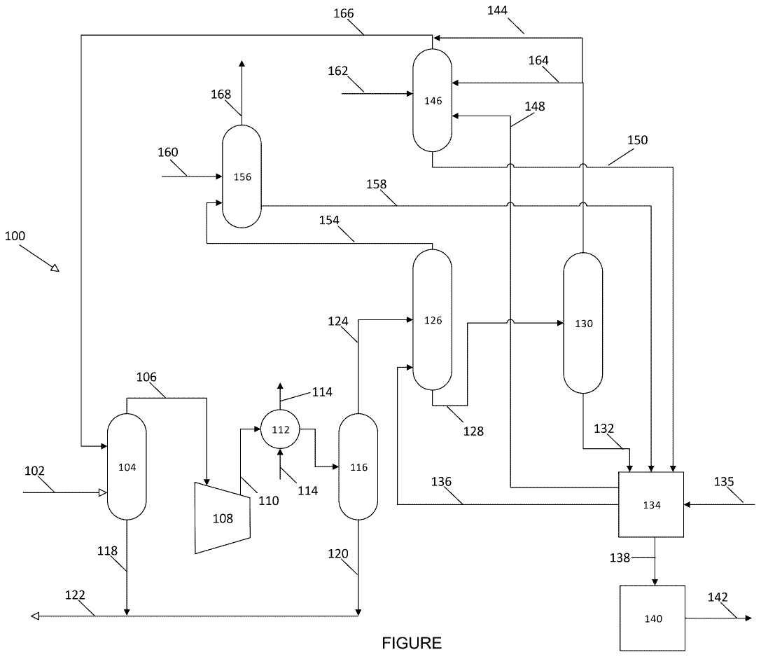

### BACKGROUND

Hydrogen sulfide is a major source of pollution of gas streams since it is liberated as a waste by-product in a number of chemical processes, such as sulfate or kraft paper pulp manufacture, viscose manufacture, sewage treatment, the production of organic sulfur compounds, as well as during petroleum refining and in the production of natural gas and combustible gases from coal, such as in coking operations. Hydrogen sulfide is also present in geothermal steams, which is captured for use in power generating plants.

To eliminate these polluting sulfur gases, a gas conditioning system is utilized which may include oxidation-reduction (“redox”) processes that use an aqueous chelated metal catalyst solution for removing hydrogen sulfide from a gas stream. In these processes a hydrogen sulfide-containing gas, known as “sour gas,” is contacted with a chelated metal catalyst to effect absorption. Subsequent oxidation of the hydrogen sulfide to elemental sulfur and concurrent reduction of the metal to a lower oxidation state also occurs. The catalyst solution is then regenerated for reuse by contacting it with an oxygen-containing gas to oxidize the metal back to a higher oxidation state. The elemental sulfur is continuously removed from the process as a solid product with high purity. Gas conditioning systems often utilize high pressure processing which allows for larger equipment and volumetric throughput at the expense of increased emissions associated with flaring hydrogen sulfide containing flash gases generated in the gas conditioning process.

### SUMMARY

Disclosed herein is an example system for treating hydrogen sulfide including: a source of hydrogen sulfide containing gas fluidically coupled to a suction drum; a compressor or blower fluidically coupled to the suction drum wherein the compressor or blower is configured to compress the hydrogen sulfide containing gas to form a compressed gas stream; an absorber vessel fluidically coupled to the compressed gas stream and a source of redox solution comprising a redox solution wherein the absorber vessel is configured to contact the compressed gas stream and the redox solution; and a flash drum fluidically coupled to the absorber vessel wherein the flash drum is configured to flash a bottoms stream from the absorber vessel to form a first overhead stream, wherein the first overhead stream is fluidically coupled to the suction drum.

Further disclosed herein is an example method for treating hydrogen sulfide comprising: introducing a hydrogen sulfide containing gas into a suction drum, wherein the hydrogen sulfide containing gas comprises hydrogen sulfide and hydrocarbon gases; conveying the hydrogen sulfide containing gas from the suction drum to an absorber vessel; contacting the hydrogen sulfide containing gas with a redox solution in the absorber vessel and reacting the hydrogen sulfide containing gas with the redox solution to form a bottoms stream comprising elemental sulfur, spent redox solution, and residual hydrogen sulfide; introducing the bottoms stream into a flash drum and flashing the bottoms stream to form an overhead stream comprising flashed hydrocarbon gases and the residual hydrogen sulfide; and conveying the overhead stream comprising the flashed hydrocarbon gases and residual hydrogen sulfide to the suction drum.

Further disclosed herein is an example method for treating hydrogen sulfide comprising: introducing a hydrogen sulfide containing gas into a suction drum; conveying the hydrogen sulfide containing gas from the suction drum to an absorber vessel; contacting the hydrogen sulfide containing gas with a redox solution in the absorber vessel and reacting the hydrogen sulfide containing gas with the redox solution to form a bottoms stream comprising elemental sulfur, spent redox solution, and residual hydrogen sulfide; introducing the bottoms stream into a flash drum and flashing the bottoms stream to form an overhead stream comprising the residual hydrogen sulfide; conveying the overhead stream comprising the residual hydrogen sulfide to a wash column; contacting the overhead stream comprising the residual hydrogen sulfide with the redox solution in the wash column; and withdrawing a second overhead stream from the wash column and conveying the second overhead stream to the suction drum.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

These drawings illustrate certain aspects of some of the embodiments of the present invention and should not be used to limit or define the invention.

FIGURE is a schematic illustration of a gas conditioning system for treatment of hydrogen sulfide containing gas streams, in accordance with embodiments of the present disclosure.

### DETAILED DESCRIPTION

Disclosed herein are gas conditioning systems and methods for treating hydrogen sulfide containing gas streams and, more particularly, disclosed are gas conditioning systems and methods with integrated flash gas recovery for reduced atmospheric emissions. The presently disclosed gas conditioning systems reduce atmospheric emissions by capturing and treating flash gases to recover additional sulfur and hydrocarbons thereby eliminating the need for flaring or combustion of the flash gases generated from treating the hydrogen sulfide containing gas stream.

FIGURE is a schematic illustration of a gas conditioning system and process 100 for treatment of hydrogen sulfide containing gas streams, in accordance with embodiments of the present disclosure. A shown in FIGURE, hydrogen sulfide containing gas stream 102 is introduced into suction drum 104 where liquids present in hydrogen sulfide containing gas stream 102 are separated to form stream 118. Suction drum 104 may include internals such as mesh pads or vane packs to enhance liquid removal from hydrogen sulfide containing gas stream 102. The hydrogen sulfide containing gas stream 102 may be from any source which produces or contains hydrogen sulfide, including, but not limited to sulfate or kraft paper pulp manufacture streams, viscose manufacture streams, sewage treatment streams, petroleum refining streams, petroleum and/or gas production streams, and/or coking streams, for example. Other feed streams containing hydrogen sulfide can be processed, including those containing sour gas, refined products, fuel gas, synthesis gas, acid gas, natural gas, landfill gas, sour air, stripper overhead, crude oil, hydrocarbons, sour flash gases, and well treating fluids, for example. In some embodiments, the hydrogen sulfide containing gas stream 102 is generated during the production of oil and gas from a reservoir, such as from surface equipment including oil/gas separators and/or oil/water separators.

The separated gases from suction drum 104, including hydrogen sulfide, are withdrawn via line 106 and introduced into compressor, or alternatively a blower, 108. Suction drum 104 is operated at the suction pressure of compressor 108, such as at a point in a range of from 10 psig to 100 psig. Compressor 108 may include any suitable compressor type such as centrifugal type, scroll type, and/or reciprocating type. Compressor 108 compresses the gases in line 106 to a higher pressure than suction drum 104, such as a pressure at a point in a range of from 20 psig to 1000 psig, but more preferably from 100 to 400 psig, to form compressed gas stream 110 which is then fed to heat exchanger 112. In heat exchanger 112 the compressed gases in compressed gas stream 110 are cooled to a lower temperature such as in a range of from 50° F. to 150° F., by thermally contacting compressed gas stream 110 with cooling medium 114. From heat exchanger 112, the cooled compressed gas stream 110 is introduced into knock-out drum 116. Knock-out drum 116 may include internals such as mesh pads, vane packs, and/or baffles to separate moisture and hydrocarbon condensates from cooled compressed gas stream 110 which are withdrawn from knock-out drum 116 as stream 120. Stream 120 from knock-out drum 116 and stream 118 from suction drum 104 may be combined to form sour condensate stream 122 which may be disposed of or treated by conventional processes.

The separated gases from knock-out drum 116, including hydrogen sulfide, are withdrawn via line 124 and introduced into absorber vessel 126. Redox solution stream 136 is withdrawn from oxidizer vessel 134 and introduced into absorber vessel 126 where the redox solution from redox solution stream 136 and the hydrogen sulfide from line 124 are contacted and reacted. The liquid redox solution may include an aqueous chelated metal catalyst solution. The aqueous chelated metal catalyst solution may include iron, such as ferric iron Fe³⁺, chelated with a chelating agent to keep the iron soluble and active across a range of pH. The sour gas containing hydrogen sulfide is contacted with the chelated iron solution which oxidizes the hydrogen sulfide to elemental sulfur and reduces the iron to ferrous iron Fe²+. In further embodiments, the redox solution contains pentavalent vanadium V⁺⁵ and the contacting with hydrogen sulfide produces elemental sulfur and reduces the vanadium to V⁺⁴. Absorber vessel 126 may be operated as an elevated pressure such as a pressure at a point in a range of from 100 psig to 400 psig.

Absorber vessel 126 may be configured in an up-flow configuration whereby the gases from line 124 are introduced into a bottom portion of absorber vessel 126 and the redox solution from redox solution stream 136 are introduced into a top portion of absorber vessel 126 to allow for counter-current contact of the gases with the redox solution. In some embodiments the absorber vessel 126 is a bubble column and includes equipment such as gas distributors or other equipment to allow for distribution of the gases within absorber vessel 126 to allow for efficient sparging of the gases into the redox solution. In further embodiments, the absorber vessel 126 is a packed column which contains solid media, a liquid full absorber, a static mixer, or is a vessel comprising venturis or mobile bed absorbers.

After reaction with the redox solution, the gases entering the absorber vessel 126 from line 124 have a reduced concentration of hydrogen sulfide. In some embodiments, the gases are withdrawn from absorber vessel 126 through overhead stream 154 and introduced into wash column 156. In wash column 156 the gases from overhead stream 154 are contacted with water from stream 160. The water in wash column 156 removes any substantial iron redox solution or elemental sulfur from overhead stream 154 which might not have fully separated before exiting absorber vessel 126. In some embodiments, the overhead stream 154 bypasses a wash column and the gases in overhead stream 154 proceed directly to treated gas stream 168, substantially free of hydrogen sulfide. In some embodiments the wash column 156 is a bubble column and includes equipment such as gas distributors or other equipment to allow for distribution of the gases within wash column 156 to allow for efficient sparging of the gases into the redox solution and/or water. In further embodiments, the wash column 156 is a packed column which contains solid media. Wash column 156 may include internals such as mesh pads, vane packs, and/or baffles to separate moisture and gases. Treated gas stream 168 containing the cleaned gases substantially free of hydrogen sulfide, such as less than 1 ppm, is withdrawn from wash column 156. Additionally, stream 158 containing water and/or redox solution is withdrawn from wash column 156 and introduced into oxidizer vessel 134.

Bottoms stream 128 containing elemental sulfur, spent redox solution and/or water as well as any residual hydrogen sulfide is withdrawn from absorber vessel 126 and introduced into flash drum 130. In flash drum 130, the components of bottoms stream 128 are flashed to a lower pressure than the operating pressure of the absorber vessel 126, such as a pressure at a point in a range of from 20 psig to 200 psig. The flash process separates the more volatile components including residual hydrogen sulfide and hydrocarbons from the bulk liquid including suspended elemental sulfur, water, and/or spent redox solution.

Bottoms stream 132 containing suspended elemental sulfur, water, spent redox solution, and/or condensed hydrocarbons is withdrawn from flash drum 130 and introduced into oxidizer vessel 134. In oxidizer vessel 134 spent redox solution is contacted with an oxygen-containing gas 135 to regenerate the redox solution. In embodiments the spent redox solution including ferrous iron Fe²⁺ is oxidized in oxidizer vessel 134 to regenerate the redox solution including ferric iron Fe³⁺. The regenerated redox solution is fed back to the process through redox solution stream 136 and 148. The sulfur is recovered from the bottom of the oxidizer vessel 134 as a slurry of sulfur and redox solution in bottoms stream 138 which is fed to sulfur recovery system 140. The sulfur/redox slurry may be pumped to sulfur recovery system 140 which may include several processes for separating components from bottoms stream 138 including a water wash system and a sulfur melter or separator where the sulfur is separated from water and redox solution. Sulfur is withdrawn from sulfur recovery system 140 as sulfur stream 142 and redox solution separated from bottoms stream 138 may be recycled to oxidizer vessel 134, for example.

From flash drum 130, separated gases from the flash process are withdrawn as overhead stream 144 and combined with stream 166 and recycled back to suction drum 104 thereby recycling the flash gases. In some embodiments, all or a portion of the flash gases from overhead stream 144 are directed to stream 164 and into optional wash column 146. Optional wash column 146 can be utilized to further reduce process contaminants reaching compressor 108. In embodiments, separated gases from the flash process are introduced to optional wash column 146 and contacted with water from stream 162 and redox solution from redox solution stream 148 to further reduce hydrogen sulfide concentration in the gases. In some embodiments, optional wash column 146 is a bubble column and includes equipment such as gas distributors or other equipment to allow for distribution of the gases within optional wash column 146 to allow for efficient sparging of the gases into the redox solution and/or water. In further embodiments, the optional wash column 146 is a packed column which contains solid media. Optional wash column 146 may include internals such as mesh pads, vane packs, and/or baffles to separate moisture and gases. Treated gas stream containing the cleaned gases with reduced concentration of hydrogen sulfide, as compared to the gases entering from stream 164, are withdrawn from optional wash column 146 to stream 166. Additionally, stream 150 containing water and/or redox solution is withdrawn from optional wash column 146 and introduced into oxidizer vessel 134.

The redox solution utilized herein may include iron or vanadium, a chelating agent, and a pH stabilizer. In embodiments, the above disclosed process employs a solution of ferric iron (Fe³⁺) stabilized by chelating agents, which facilitates the oxidation of H₂S to sulfur (2Fe³⁺+H₂S→2Fe²⁺+S⁰+2H⁺) in the absorber vessel. The reduced ferrous iron (Fe^{2 +}) is then regenerated back to Fe³⁺ in an oxidizer using oxygen from air or other sources (4Fe²⁺+O₂+4H⁺→4Fe³⁺+2H₂O), allowing continuous recycling of the solution. In some embodiments, vanadium, particularly, in its +5 valence state (V⁵⁺) , can be utilized alone or in combination with ferric iron. In some embodiments, the chelating agents include EDTA (ethylenediaminetetraacetic acid), HEDTA (hydroxyethylethylenediaminetriacetic acid), NTA (nitrilotriacetic acid), DTPA (diethylenetriaminepentaacetic acid), citric acid, or combinations thereof. These chelating agents form complexes with Fe³⁺ and Fe²⁺ (or V⁵⁺ if used) thereby preventing precipitation as insoluble hydroxides or sulfides, which may occur in the presence of water, oxygen, or sulfur byproducts. The redox solution's pH may be any suitable pH, typically between 8 and 10, which may be maintained using a pH stabilizer such as sodium hydroxide (NaOH), potassium carbonate (K₂CO₃), or other buffer solutions. The pH may be maintained as slightly alkaline to enhance hydrogen sulfide absorption into the aqueous phase (as HS⁻ ions) and to prevent acidification from the protons released during sulfur formation.

### Additional Embodiments

Accordingly, the present disclosure may provide systems and methods for treating hydrogen sulfide containing gas streams and, more particularly, disclosed are gas conditioning systems and methods with integrated flash gas recovery for reduced atmospheric emissions. The systems and methods may include any of the various features disclosed herein, including one or more of the following statements.

Statement 1. A system for treating hydrogen sulfide comprising: a source of hydrogen sulfide containing gas fluidically coupled to a suction drum; a compressor or blower fluidically coupled to the suction drum wherein the compressor or blower is configured to compress the hydrogen sulfide containing gas to form a compressed gas stream; an absorber vessel fluidically coupled to the compressed gas stream and a source of redox solution comprising a redox solution wherein the absorber vessel is configured to contact the compressed gas stream and the redox solution; and a flash drum fluidically coupled to the absorber vessel wherein the flash drum is configured to flash a bottoms stream from the absorber vessel to form a first overhead stream, wherein the first overhead stream is fluidically coupled to the suction drum.

Statement 2. The system of statement 1 wherein the absorber vessel comprises at least one vessel selected from the group consisting of bubble column, packed column, liquid full absorber, and static mixer.

Statement 3. The system of statement 1 wherein the absorber vessel is further configured to generate a second overhead stream comprising gas with reduced hydrogen sulfide concentration.

Statement. The system of statement 3 further comprising a wash column fluidically coupled to the second overhead stream and the source of redox solution wherein the wash column is configured to contact the second overhead stream with the redox solution to generate a treated gas stream substantially free of hydrogen sulfide.

Statement 5. The system of statement 1 further comprising a knock-out drum fluidically coupled to the compressed gas stream and the absorber vessel and positioned between the compressed gas stream and the absorber vessel.

Statement 6. The system of statement 1 further comprising a wash column fluidically coupled to the first overhead stream and the source of redox solution wherein the wash column is configured to contact the first overhead stream with the redox solution to generate a third overhead stream, wherein the third overhead stream is fluidically coupled to the suction drum.

Statement 7. The system of statement 1 further comprising an oxidizer vessel fluidically coupled to a bottoms stream from flash drum, wherein the bottoms stream from the flash drum comprises spent redox solution, and wherein the oxidizer vessel is configured to oxidize the spent redox solution.

Statement 8. The system of statement 1 wherein the source of redox solution comprises an aqueous chelated metal catalyst solution.

Statement 9. The system of statement 8 wherein the aqueous chelated metal catalyst solution comprises at least one of metal selected from the group consisting of ferric iron, pentavalent vanadium, and combinations thereof.

Statement 10. A method for treating hydrogen sulfide comprising: introducing a hydrogen sulfide containing gas into a suction drum, wherein the hydrogen sulfide containing gas comprises hydrogen sulfide and hydrocarbon gases; conveying the hydrogen sulfide containing gas from the suction drum to an absorber vessel; contacting the hydrogen sulfide containing gas with a redox solution in the absorber vessel and reacting the hydrogen sulfide containing gas with the redox solution to form a bottoms stream comprising elemental sulfur, spent redox solution, and residual hydrogen sulfide; introducing the bottoms stream into a flash drum and flashing the bottoms stream to form an overhead stream comprising flashed hydrocarbon gases and the residual hydrogen sulfide; and conveying the overhead stream comprising the flashed hydrocarbon gases and residual hydrogen sulfide to the suction drum.

Statement 11. The method of statement 10 further comprising: withdrawing the hydrogen sulfide containing gas from the suction drum to a compressor and compressing the hydrogen sulfide containing gas to form a compressed hydrogen sulfide containing gas; and conveying the compressed hydrogen sulfide containing gas to the absorber vessel.

Statement 12. The method of statement 11 further comprising: conveying the compressed hydrogen sulfide containing gas to a knock-out drum; separating hydrocarbon condensate from the compressed hydrogen sulfide containing gas in the knock-out drum; and conveying the compressed hydrogen sulfide containing gas with reduced concentration of hydrocarbon condensate to the absorber vessel.

Statement 13. The method of statement 10 further comprising: regenerating the spent redox solution by oxidizing the spent redox solution in an oxidizer vessel.

Statement 14. The method of statement 13 further comprising: withdrawing a second overhead stream from the absorber vessel, wherein the second overhead stream comprises residual hydrogen sulfide and the hydrocarbons; conveying the second overhead stream to a wash column; contacting the second overhead stream with the redox solution in the wash column; and withdrawing a treated gas stream from the wash column, wherein the treated gas stream comprises the hydrocarbons and less than 1 ppm hydrogen sulfide.

Statement 15. The method of statement 10 further comprising: conveying the overhead stream comprising the residual hydrogen sulfide to a wash column; contacting the overhead stream comprising the residual hydrogen sulfide with the redox solution in the wash column; and withdrawing a second overhead stream from the wash column and conveying the second overhead stream to the suction drum.

Statement 16. The method of statement 10 wherein the redox solution comprises an aqueous chelated metal catalyst solution, wherein the aqueous chelated metal catalyst solution comprises at least one of metal selected from the group consisting of ferric iron, pentavalent vanadium, and combinations thereof.

Statement 17. A method for treating hydrogen sulfide comprising: introducing a hydrogen sulfide containing gas into a suction drum; conveying the hydrogen sulfide containing gas from the suction drum to an absorber vessel; contacting the hydrogen sulfide containing gas with a redox solution in the absorber vessel and reacting the hydrogen sulfide containing gas with the redox solution to form a bottoms stream comprising elemental sulfur, spent redox solution, and residual hydrogen sulfide; introducing the bottoms stream into a flash drum and flashing the bottoms stream to form an overhead stream comprising the residual hydrogen sulfide; conveying the overhead stream comprising the residual hydrogen sulfide to a wash column; contacting the overhead stream comprising the residual hydrogen sulfide with the redox solution in the wash column; and withdrawing a second overhead stream from the wash column and conveying the second overhead stream to the suction drum.

Statement 18. The method of statement 17 wherein the hydrogen sulfide containing gas further comprises hydrocarbons.

Statement 19. The method of statement 18 further comprising: withdrawing a third overhead stream from the absorber vessel, wherein the third overhead stream comprises residual hydrogen sulfide and the hydrocarbons; conveying the third overhead stream to a wash column; contacting the third overhead stream with the redox solution in the wash column; and withdrawing a treated gas stream from the wash column, wherein the treated gas stream comprises the hydrocarbons and less than 1 ppm hydrogen sulfide.

Statement 20. The method of statement 17 wherein the redox solution comprises an aqueous chelated metal catalyst solution, wherein the aqueous chelated metal catalyst solution comprises at least one of metal selected from the group consisting of ferric iron, pentavalent vanadium, and combinations thereof.

It is to be understood that the present disclosure is not limited to particular systems or methods, which may, of course, vary. It is also to be understood that the terminology used herein is for the purpose of describing particular embodiments only and is not intended to be limiting. All numbers and ranges disclosed herein may vary by some amount. Whenever a numerical range with a lower limit and an upper limit is disclosed, any number and any included range falling within the range are specifically disclosed. Although individual embodiments are discussed herein, the invention covers all combinations of all those embodiments. As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. If there is any conflict in the usages of a word or term in this specification and one or more patent or other documents that may be incorporated herein by reference, the definitions that are consistent with this specification should be adopted for the purposes of understanding this invention.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

What is claimed is:

1. A system for treating hydrogen sulfide comprising:
a source of hydrogen sulfide containing gas fluidically coupled to a suction drum;
a compressor or blower fluidically coupled to the suction drum wherein the compressor or blower is configured to compress the hydrogen sulfide containing gas to form a compressed gas stream;
an absorber vessel fluidically coupled to the compressed gas stream and a source of redox solution comprising a redox solution wherein the absorber vessel is configured to contact the compressed gas stream and the redox solution; and
a flash drum fluidically coupled to the absorber vessel wherein the flash drum is configured to flash a bottoms stream from the absorber vessel to form a first overhead stream, wherein the first overhead stream is fluidically coupled to the suction drum.

2. The system of claim 1 wherein the absorber vessel comprises at least one vessel selected from the group consisting of bubble column, packed column, liquid full absorber, and static mixer.

3. The system of claim 1 wherein the absorber vessel is further configured to generate a second overhead stream comprising gas with reduced hydrogen sulfide concentration.

4. The system of claim 3 further comprising a wash column fluidically coupled to the second overhead stream and the source of redox solution wherein the wash column is configured to contact the second overhead stream with the redox solution to generate a treated gas stream substantially free of hydrogen sulfide.

5. The system of claim 1 further comprising a knock-out drum fluidically coupled to the compressed gas stream and the absorber vessel and positioned between the compressed gas stream and the absorber vessel.

6. The system of claim 1 further comprising a wash column fluidically coupled to the first overhead stream and the source of redox solution wherein the wash column is configured to contact the first overhead stream with the redox solution to generate a third overhead stream, wherein the third overhead stream is fluidically coupled to the suction drum.

7. The system of claim 1 further comprising an oxidizer vessel fluidically coupled to a bottoms stream from flash drum, wherein the bottoms stream from the flash drum comprises spent redox solution, and wherein the oxidizer vessel is configured to oxidize the spent redox solution.

8. The system of claim 1 wherein the source of redox solution comprises an aqueous chelated metal catalyst solution.

9. The system of claim 8 wherein the aqueous chelated metal catalyst solution comprises at least one of metal selected from the group consisting of ferric iron, pentavalent vanadium, and combinations thereof.

10. A method for treating hydrogen sulfide comprising:
introducing a hydrogen sulfide containing gas into a suction drum, wherein the hydrogen sulfide containing gas comprises hydrogen sulfide and hydrocarbon gases;
conveying the hydrogen sulfide containing gas from the suction drum to an absorber vessel;
contacting the hydrogen sulfide containing gas with a redox solution in the absorber vessel and reacting the hydrogen sulfide containing gas with the redox solution to form a bottoms stream comprising elemental sulfur, spent redox solution, and residual hydrogen sulfide;
introducing the bottoms stream into a flash drum and flashing the bottoms stream to form an overhead stream comprising flashed hydrocarbon gases and the residual hydrogen sulfide; and
conveying the overhead stream comprising the flashed hydrocarbon gases and residual hydrogen sulfide to the suction drum.

11. The method of claim 10 further comprising:
withdrawing the hydrogen sulfide containing gas from the suction drum to a compressor and compressing the hydrogen sulfide containing gas to form a compressed hydrogen sulfide containing gas; and
conveying the compressed hydrogen sulfide containing gas to the absorber vessel.

12. The method of claim 11 further comprising:
conveying the compressed hydrogen sulfide containing gas to a knock-out drum;
separating hydrocarbon condensate from the compressed hydrogen sulfide containing gas in the knock-out drum; and
conveying the compressed hydrogen sulfide containing gas with reduced concentration of hydrocarbon condensate to the absorber vessel.

13. The method of claim 10 further comprising:
regenerating the spent redox solution by oxidizing the spent redox solution in an oxidizer vessel.

14. The method of claim 13 further comprising:
withdrawing a second overhead stream from the absorber vessel, wherein the second overhead stream comprises residual hydrogen sulfide and the hydrocarbons;
conveying the second overhead stream to a wash column;
contacting the second overhead stream with the redox solution in the wash column; and
withdrawing a treated gas stream from the wash column, wherein the treated gas stream comprises the hydrocarbons and less than 1 ppm hydrogen sulfide.

15. The method of claim 10 further comprising:
conveying the overhead stream comprising the residual hydrogen sulfide to a wash column;
contacting the overhead stream comprising the residual hydrogen sulfide with the redox solution in the wash column; and
withdrawing a second overhead stream from the wash column and conveying the second overhead stream to the suction drum.

16. The method of claim 10 wherein the redox solution comprises an aqueous chelated metal catalyst solution, wherein the aqueous chelated metal catalyst solution comprises at least one of metal selected from the group consisting of ferric iron, pentavalent vanadium, and combinations thereof.

17. A method for treating hydrogen sulfide comprising:
introducing a hydrogen sulfide containing gas into a suction drum;
conveying the hydrogen sulfide containing gas from the suction drum to an absorber vessel;
contacting the hydrogen sulfide containing gas with a redox solution in the absorber vessel and reacting the hydrogen sulfide containing gas with the redox solution to form a bottoms stream comprising elemental sulfur, spent redox solution, and residual hydrogen sulfide;
introducing the bottoms stream into a flash drum and flashing the bottoms stream to form an overhead stream comprising the residual hydrogen sulfide;
conveying the overhead stream comprising the residual hydrogen sulfide to a wash column;
contacting the overhead stream comprising the residual hydrogen sulfide with the redox solution in the wash column; and
withdrawing a second overhead stream from the wash column and conveying the second overhead stream to the suction drum.

18. The method of claim 17 wherein the hydrogen sulfide containing gas further comprises hydrocarbons.

19. The method of claim 18 further comprising:
withdrawing a third overhead stream from the absorber vessel, wherein the third overhead stream comprises residual hydrogen sulfide and the hydrocarbons;
conveying the third overhead stream to a wash column;
contacting the third overhead stream with the redox solution in the wash column; and
withdrawing a treated gas stream from the wash column, wherein the treated gas stream comprises the hydrocarbons and less than 1 ppm hydrogen sulfide.

20. The method of claim 17 wherein the redox solution comprises an aqueous chelated metal catalyst solution, wherein the aqueous chelated metal catalyst solution comprises at least one of metal selected from the group consisting of ferric iron, pentavalent vanadium, and combinations thereof.
